(19) United States
(12) Patent Application Publication
(10) Pub. No.: US 2014/0114766 A1
(43) Pub. Date: Apr. 24, 2014

(54) APPARATUS AND METHOD FOR PROVIDING ADVERTIZING SERVICE TO PLURALITY OF MOBILE DEVICES

(71) Applicant: Electronics and Telecommunications Research Institute, Daejeon (KR)

(72) Inventors: Uk JANG, Daejeon-si (KR); Hwa-Suk KIM, Daejeon-si (KR); Hyun-Jin LEE, Daejeon-si (KR); Dong-Hun LEE, Daejeon-si (KR); Eun-Il KIM, Seoul (KR); Kee-Seong CHO, Daejeon-si (KR); Won RYU, Daejeon-si (KR)

(73) Assignee: Electronics and Telecommunications Research Institute, Daejeon (KR)

(21) Appl. No.: 14/057,852

(22) Filed: Oct. 18, 2013

(30) Foreign Application Priority Data
Oct. 19, 2012 (KR) 10-2012-0116937
Jun. 20, 2013 (KR) 10-2013-0071222

(51) Int. Cl. G06Q 30/02; H04W 4/06

(52) U.S. Cl. CPC G06Q 30/0267; H04W 4/06
USPC 705/14.64

(57) ABSTRACT

A method for providing an advertisement from a digital signage control apparatus to multiple mobile devices accessible to an access point installed in a digital signage terminal. The method may include determining whether the number of the mobile devices requesting the identical advertisement for a predetermined amount of time is greater than a threshold, and if the number of the mobile devices is greater than the threshold, transmitting the identical advertisement to the mobile devices through a multicast channel.

### CROSS-REFERENCE TO RELATED APPLICATION(S)

This application claims the benefit under 35 U.S.C. §119(a) of Korean Patent Application No. 10-2012-0116937, filed on Oct. 19, 2012, and No. 10-2013-0071222, filed on June 20, 2013, in the Korean Intellectual Property Office, the entire disclosure of which is incorporated herein by reference for all purposes.

### BACKGROUND

1. Field

The following description relates to digital signage technology, more specifically, an apparatus and method for providing advertising service to a plurality of mobile devices with which users wirelessly access a digital signage terminal.

2. Description of the Related Art

Digital signage technology is one that enables an outdoor signboard for advertising to be displayed in a digital form through digital image devices. The devices using such digital signage technology provide text, image, or video content, by grafting mostly outdoor advertisement displays.

The function of the devices providing digital signage technology have mainly focused on services within the digital signage itself rather than content transmission to mobile devices. So, in providing content, the devices have performed content installation, operation, and replacement on the digital signage itself.

However, following recent developments in communication networks, the digital signage may be controlled from a long distance through the network. Also, interaction with a user is enhanced, and the devices are progressing towards providing a customized digital signage service appropriate for a user's attributes or surroundings. Thus, content transmission occurring through the interaction between a digital signage terminal and a user's mobile device is frequently generated.

On the other hand, bandwidth insufficiency occurs as a result of content transmission to multiple users' mobile devices in a wireless network environment with limited resources. Such bandwidth insufficiency can lead to problems with the smooth performance of a content providing service.

### SUMMARY

In one general aspect, a method for providing an advertising service from a digital signage control apparatus to multiple mobile devices accessible to an access point installed in a digital signage terminal may include determining whether a number of mobile devices requesting an identical advertisement for a predetermined amount of time is greater than a threshold; and if the number of the mobile devices is greater than the threshold, transmitting the identical advertisement to the mobile devices through a multicast channel.

The transmitting of the identical advertisement may include transmitting information for a multicast channel subscription to the mobile devices, and multicasting the identical advertisement through the mobile devices that have subscribed to the multicast channel.

In another general aspect, a method for providing an advertising service from a digital signage control apparatus to multiple mobile devices accessible to an access point installed in a digital signage terminal may include determining whether n(X) is greater than N, wherein n(X) is a number of advertisements, and N is a number of all the multicast channels; if n(X) is greater than N, dividing whole bandwidth that is allocated to all the multicast channels by n(X) and allocating the divided bandwidth to each multicast channel; and transmitting the advertisement through the multicast channels where the divided bandwidth each allocated.

The determining of whether n(X) is greater than N may include counting Y, wherein Y is a number of advertisements simultaneously requested for a predetermined amount of time; determining whether Y is greater than N; and if Y is greater than N, determining whether n(X) is greater than N.

After the dividing of the whole bandwidth, the method may further include reducing advertising video quality.

The reducing of the advertising video quality may include changing a video encoding means.

The reducing of the advertising video quality may include selecting video sources that include a rate that is less than a predetermined value.

In another general aspect, a digital signage control apparatus for providing an advertising service to multiple mobile devices accessible to an access point installed in a digital signage terminal may include a counter to count mobile devices requesting an identical advertisement for a predetermined amount of time; and a multicast transmission unit to, if a number of the mobile devices counted by the counter is greater than a threshold, transmit the identical advertisement to the mobile devices through a multicast channel.

The multicast transmission unit may transmit information for a multicast channel subscription, and multicast the advertisement to the mobile devices that have subscribed to the multicast channel.

The digital signage control apparatus may further include a wireless resources management unit to, if n(X) is greater than N, divide whole bandwidth allocated to the multicast channel by n(X), wherein n(X) is a number of the advertisements to be transmitted through the multicast channel, and N is a number of all the multicast channels.

The digital signage control apparatus may further include a video coding unit to, if the whole bandwidth is divided by the wireless resources management unit, reduce advertising video quality.

The video coding unit may change a video encoding means.

The video coding unit may select video sources that include a rate that is less than a predetermined value.

Other features and aspects may be apparent from the following detailed description, the drawings, and the claims.

### BRIEF DESCRIPTION OF THE DRAWINGS

FIG. 1 is a diagram illustrating an example of a digital signage system for providing an advertising service to a plurality of mobile devices.

FIG. 2 is a diagram illustrating an example of a method for providing an advertising service to a plurality of mobile devices.

FIG. 3 is a diagram illustrating another example of a method for providing an advertising service to a plurality of mobile devices.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

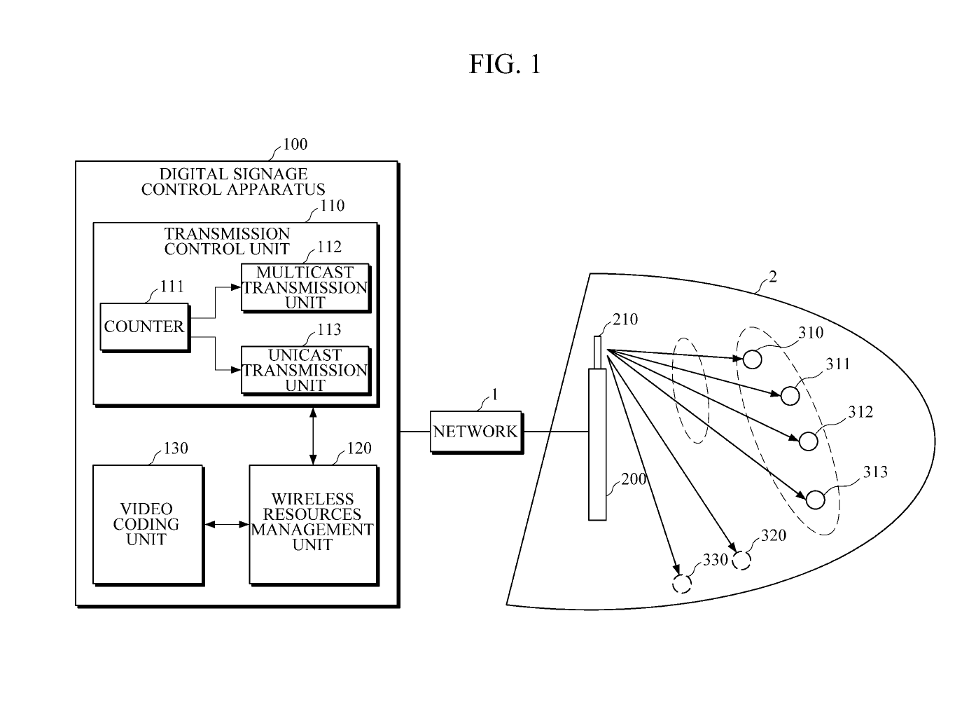

FIG. 1 is a diagram illustrating an example of a digital signage system for providing an advertising service to a plurality of mobile devices.

Referring to FIG. 1, a digital signage control apparatus 100 provides an advertising service to a digital signage terminal 200, which is connected to the apparatus 100 via network 1. Here, the network 1 may be a Wireless Local Area Network (WLAN), Wi-Fi®, Wireless Broadband (Wibro), World Interoperability for Microwave Access (Wimax), and High Speed Downlink Packet Access (HSDPA), etc.

The digital signage terminal 200 is a digital image device that displays a video or text information through a flat panel display or projector, etc. using digital technology. Also, the terminal 200 may provide not only broadcasting programs, but also specific information in public places, such as airports, hotels, or hospitals, etc., as a communication tool to induce a company's marketing, advertising, training, and customer experience. In an embodiment, wireless access point (AP) 210 is attached to the digital signage terminal 200, and users' one and more mobile devices 310, 311, 312, 313, 320, and 330 within a service range 2 of the wireless AP 210 access the digital signage apparatus 100 to provide services that an individual wants.

The mobile devices 310, 311, 312, 313, 320, and 330 may be executed by terminals that have arithmetic operation capacity, equipped with a memory means, and mounted microprocessors, such as cell phones, smart phones, notebook computers, terminals for digital broadcasting, Personal Digital Assistants (PDA), Portable Multimedia Players (PMP), and GPS navigation systems (vehicle navigation equipment), etc.

The digital signage control apparatus 100 performs a function to control the digital signage terminal 200 through the network 1, controls switching between a unicast or multicast advertising service, and executes resources management.

That is, in a situation where an individual receives a desired service through multiple mobile devices accessing the wireless AP 210, using the unicast channel when a capacity of the wireless AP 210 is over its limit will cause service quality decline, such as causing the video to stop. To solve these problems, according to an exemplary embodiment, the digital signage control apparatus 100 binds the mobile devices 310, 311, 312, and 312 that request the identical advertisement into the same group, and provides the multicast service. Through those operations, the apparatus 100 may accommodate many more simultaneous users, and provide seamless service for users.

The digital signage control apparatus 100 specifically includes a transmission control unit 110, a wireless resources management unit 120, and a video coding unit 130.

A transmission control unit 110 in detail includes a counter 111, a multicast transmission unit 112, and a unicast transmission unit 113.

A counter 111 counts the number of mobile devices that have requested the identical advertisement for a predetermined amount of time. If the number of the counted mobile devices is over a threshold, the multi transmission unit 112 transmits the advertisement to the mobile devices through a multicast channel. In more detail, the multicast transmission unit 112 transmits information for a multicast channel subscription required for the transmission of advertisements to the mobile devices, and multicasts the advertisement to the mobile devices that have subscribed to the multicast channel.

A unicast transmission unit 113 transmits the advertisement to the mobile devices through a unicast channel.

If the number n(X) of advertisement to be transmitted through the multicast channel is greater than N which is the number of the multicast channels, a wireless resources management unit 120 divides whole bandwidth, which is allocated to all the multicast channels, by the number n(X) of advertisements to be transmitted to the multicast channel. More specifically, the wireless resources management unit counts the number Y of the advertisements simultaneously requested during a determined amount of wireless resources time, and then if the number Y of the advertisement is greater than the number of the multicast channel N, determines whether the number n(X) of the advertisement to be transmitted to the multicast channel is greater than the number N of all the multicast channels.

If the whole bandwidth is divided according to the request of the wireless resources management unit 120, a video coding unit 130 lowers advertising video quality. In an embodiment, the video coding unit 130 changes a video encoding method using Layered coding and SVC, etc. Also, the video coding unit 130 selects a video source with a low video rate by using HTTP Adaptive Streaming, etc.

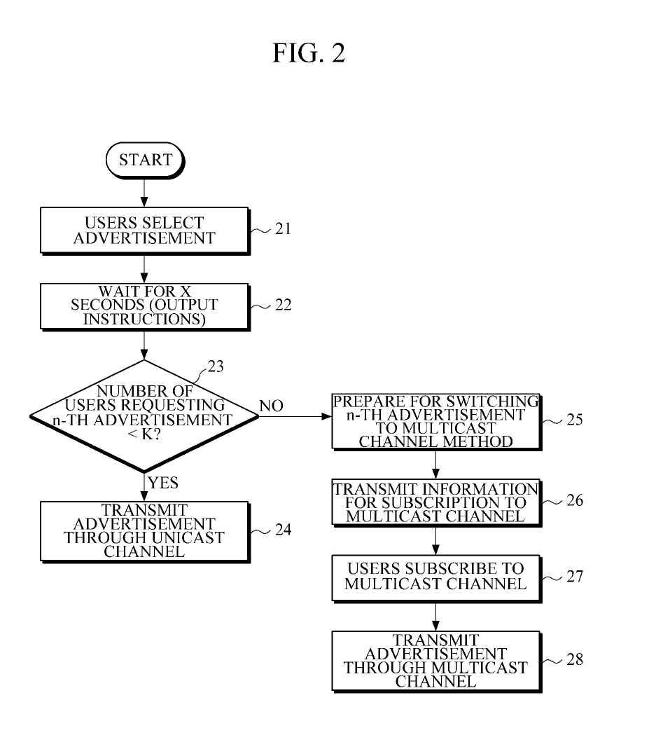

FIG. 2 is a diagram illustrating an example of a method for providing an advertising service to a plurality of mobile devices.

Referring to FIG. 2, as a user selects an advertisement through a mobile device in 21, a signal for the advertisement selection is transmitted to a digital signage control apparatus 100, and each mobile device waits for a predetermined period of time in 22. At this time, the mobile device may output instructions.

The digital signage control apparatus 100 counts the number of mobile devices simultaneously requesting n-th advertisement for a predetermined amount of time, and determines whether the number of the mobile devices is less than the pre-set threshold K in 23.

As a result of the operation 23, if the number of the mobile devices simultaneously requesting the n-th advertisement for the predetermined amount of time is less than the threshold K, the digital signage control apparatus 100 separately transmits a real-time video advertisement to each terminal via the preexisting unicast method, and plays such real-time video advertisement in 24.

On the other hand, based on a determination result of the operation 23, if the number of the mobile devices simultaneously requesting the n-th advertisement for a predetermined amount of time is greater than the threshold K, the digital signage control apparatus 100 prepares for switching the n-th advertisement to the multicast channel method in 25.

The digital signage control apparatus 100 transmits information about a multicast channel subscription to the mobile devices requesting the n-th advertisement in 26. Afterwards, the mobile devices subscribes to the multicast advertisement in 27. Then, the digital signage terminal 100 transmits the n-th advertisement to at least one mobile device that has subscribed to the multicast channel through the multicast channel in 28. As mentioned above, when the advertisement is provided via the multicast method, the digital signage control apparatus 100 can provide the advertisement to the users requesting the identical advertisement by using one multicast channel, so efficiency increases in terms of managing wireless resources.

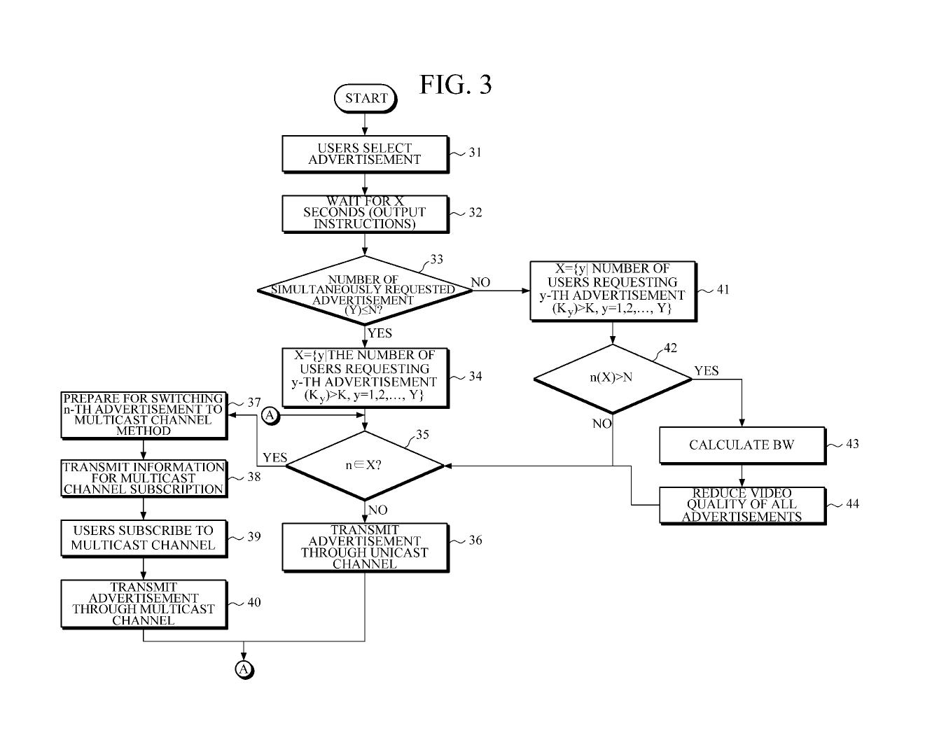

FIG. 3 is a diagram illustrating an exemplary flowchart of a method for providing advertising service to multiple mobile devices.

Prior to a description of FIG. 3, it is assumed that a bandwidth allocated for a multicast among total wireless resources exists, which can form the N number of multicast channels at present.

Referring to FIG. 3, as a user selects an advertisement through mobile devices in 31, a signal of the advertisement selection is transmitted to a digital signage control apparatus 100, and each mobile device waits for a predetermined amount of time in 32. At this time, each mobile device may output instructions.

The digital signage control apparatus 100 counts the number Y of advertisements simultaneously requested for a predetermined amount of time, and determines whether the number Y of the simultaneously requested advertisements is less than or equal to the number N of all the multicast channels in 33.

As a result of the operation 33, if the number Y of the simultaneously requested advertisements is less than or equal to the number N of all the multicast channels, the digital signage control apparatus 100 extracts advertisements transmitted through the multicast channels among the number Y of each different advertisements in 34. In other words, the digital signage control apparatus 100 extracts set X consisting of the advertisements for which the number of the users simultaneously requesting is greater than a multicast channel switching threshold K.

The digital signage control apparatus 100 determines whether an n-th advertisement is included in the set X in 35; that is, it determines whether to switch the advertisement to the multicast channel when the number of mobile devices simultaneously requesting the n-th advertisement for a predetermined amount of time is greater than threshold K.

As a determination result of the operation 35, if the number of mobile devices simultaneously requesting the n-th advertisement for a predetermined amount of time is less than the threshold K, the digital signage control apparatus 100 plays a real-time video advertisement via a preexisting unicast method in 36.

On the other hand, based on a determination result of the operation 35, if the number of the mobile devices simultaneously requesting n-th advertisement for a predetermined amount of time is greater than the threshold K, the digital signage control apparatus 100 prepares for switching the n-th advertisement to the multicast channel method in 37.

The digital signage control apparatus 100 transmits information for a multicast channel subscription to each mobile device requesting the n-th advertisement in 38. Afterwards, the mobile devices subscribe to the multicast advertisement in 39. Then, the digital signage control apparatus 100 transmits the n-th advertisement to at least one mobile device subscribing to the multicast channel through the multicast channel in 40.

On the other hand, based on a determination result of the operation of 33, if the number Y of the simultaneously requested advertisements is greater than the number N of all the multicast channels, the digital signage control apparatus 100 extracts the advertisements to be transmitted through the multicast channels among the Y number of each different advertisement in 41; that is, it extracts the set X consisting of the simultaneously requested advertisements by the user, which are greater than the multicast channel switching threshold K.

Then, the digital signage control apparatus 100 determines whether the number of the advertisements to be transmitted through the multicast channels extracted from the operation 41 is greater than the number N of all the multicast channels in 42; that is, to determine whether the number n(X) of the advertisements included in the set X is greater than the number N of all the multicast channels.

Based on a determination result of the operation 42, if the n(X) is less than N, the simultaneously requested advertisements can be switched to the multicast, so the operation 42 proceeds to 35.

However, as a determination result of the operation 42, if the n(X) is greater than the N, the simultaneously requested advertisements may not be switched to the multicast and serviced, so processes of adjusting a rate of each video source or lessening a video quality are needed.

For those processes, the digital signage control apparatus 100 checks the bandwidth allocated to the multicast channel at present, equally divides the whole bandwidth by the n(X), and increases the number of the multicast channels in 43. For example, if B MHz bandwidth is fixedly allocated to the number N of the multicast channels, the bandwidth in the amount of B/N is used in each multicast channel. However, if the (N+n) number of the multicast channels is needed, the bandwidth in the amount of B/(N+n) is allocated to each multicast channel, and consequently, the bandwidth of one multicast channel is decreased. However if there is no change to the video source when the multicast channel bandwidth is decreased, the users cannot be provided with active services.

To solve those problems, the digital signage control apparatus 100 reduces the video quality of all the advertisements in 44. The methods of reducing the video quality may include changing video encoding using Layered Coding and Scalable Video Coding (SVC), etc., and selecting video sources of a low video rate using HTTP adaptive streaming, etc.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for providing an advertising service from a digital signage control apparatus to multiple mobile devices accessible to an access point installed in a digital signage terminal, comprising:
determining whether a number of mobile devices requesting an identical advertisement for a predetermined amount of time is greater than a threshold; and
if the number of the mobile devices is greater than the threshold, transmitting the identical advertisement to the mobile devices through a multicast channel.

2. The method of claim 1, wherein the transmitting of the identical advertisement comprises transmitting information for a multicast channel subscription to the mobile devices, and multicasting the identical advertisement through the mobile devices that have subscribed to the multicast channel.

3. A method for providing an advertising service from a digital signage control apparatus to multiple mobile devices accessible to an access point installed in a digital signage terminal, comprising:
determining whether n(X) is greater than N, wherein n(X) is a number of advertisements, and N is a number of all multicast channels;
if n(X) is greater than N, dividing whole bandwidth that is allocated to all the multicast channels by n(X) and allocating the divided bandwidth to each multicast channel; and
transmitting the advertisement through the multicast channels where the divided bandwidth each is allocated.

4. The method of claim 3, wherein the determining of whether n(X) is greater than N comprises:
counting Y, wherein Y is a number of advertisements simultaneously requested for a predetermined amount of time;
determining whether Y is greater than N; and
if Y is greater than N, determining whether n(X) is greater than N.

5. The method of claim 3, further comprising:
reducing advertising video quality after the dividing of the whole bandwidth.

6. The method of claim 5, wherein the reducing of the advertising video quality comprises changing a video encoding means.

7. The method of claim 5, wherein the reducing of the advertising video quality comprises selecting video sources that include a rate that is less than a predetermined value.

8. A digital signage control apparatus for providing an advertising service to multiple mobile devices accessible to an access point installed in a digital signage terminal, comprising:
a counter configured to count mobile devices requesting an identical advertisement for a predetermined amount of time; and
a multicast transmission unit configured to, if a number of the mobile devices counted by the counter is greater than a threshold, transmit the identical advertisement to the mobile devices through a multicast channel.

9. The digital signage control apparatus of claim 8, wherein the multicast transmission unit transmits information for a multicast channel subscription, and multicasts the advertisement to the mobile devices that have subscribed to the multicast channel.

10. The digital signage control apparatus of claim 8, further comprising:
a wireless resources management unit configured to, if n(X) is greater than N, divide whole bandwidth allocated to the multicast channel by n(X), wherein n(X) is a number of the advertisements to be transmitted through the multicast channel, and N is a number of all the multicast channels.

11. The digital signage control apparatus of claim 10, further comprising:
a video coding unit configured to, if the whole bandwidth is divided by the wireless resources management unit, reduce advertising video quality.

12. The digital signage control apparatus of claim 11, wherein the video coding unit changes a video encoding means.

13. The digital signage control apparatus of claim 11, wherein the video coding unit selects video sources that include a rate that is less than a predetermined value.
